(19) United States
(12) Patent Application Publication
(10) Pub. No.: US 2022/0007678 A1
(43) Pub. Date: Jan. 13, 2022

(54) SOLUBLE LEGUME PROTEIN

(71) Applicant: ROQUETTE FRERES, Lestrem (FR)

(72) Inventor: Jorge Luis VENTUREIRA, Lille (FR)

(21) Appl. No.: 17/296,077

(22) PCT Filed: Nov. 29, 2019
(86) PCT No.: PCT/FR2019/052843

§ 371 Date: May 21, 2021

(30) Foreign Application Priority Data
Nov. 30, 2018 (FR) 18 72157

(51) Int. Cl. A23J 1/14

(52) U.S. Cl. CPC A23J 1/14

(57) ABSTRACT

The invention relates to a legume protein having a low degree of hydrolysis and excellent solubility at an acidic pH, to a method for producing same, and to the use of this protein particularly in a food, cosmetic or pharmaceutical composition.

### TECHNICAL FIELD

The invention relates to a legume protein having a low degree of hydrolysis and excellent solubility at an acidic pH, to a method for producing same, and to the use of this protein particularly in a food, cosmetic or pharmaceutical composition.

### BACKGROUND ART

Human daily requirements for proteins are between 12 and 20% of food intake. These proteins are provided equally by products of animal origin (meat, fish, eggs, dairy products) and by plant-based food (cereals, leguminous plants, seaweed).

However, in developed countries, protein intake is predominantly in the form of proteins of animal origin. And yet, numerous studies show that excessive consumption of proteins of animal origin to the detriment of plant proteins is one of the causes of increases in cancer and cardiovascular diseases.

Moreover, animal proteins have many disadvantages, both in terms of their allergenicity, regarding in particular proteins originating from milk or eggs, and in terms of the environment, in relation to the harm done by intensive farming.

Thus, there is an increasing demand from manufacturers for compounds of plant origin having beneficial nutritional and functional properties without, however, having the disadvantages of compounds of animal origin.

Since the 1970s, the pea is the seed legume which has been the most developed in Europe, predominantly in France, as an alternative protein resource to animal proteins intended for animal and human food. The pea contains approximately 27% by weight of protein substances. The term “pea” is considered here in its broadest accepted use and includes, in particular, all the wild varieties of “smooth pea” and all the mutant varieties of “smooth pea” and “wrinkled pea”, regardless of the uses for which said varieties are usually intended (human food, animal feed and/or other uses).

Pea protein, predominantly pea globulin, has been extracted and utilized industrially for a great number of years. Mention may be made, as an example of a method for extracting pea protein, of patent EP1400537. In this method, the seed is milled in the absence of water (method referred to as “dry milling”) in order to obtain a flour. This flour will then be suspended in water in order to extract the protein therefrom.

Unfortunately, this protein is known to be relatively insoluble, in particular at acidic pH. For example, the article by A. C. Y. Lam, A. Can Karaca, R. T. Tyler & M. T. Nickerson (2018) “Pea protein isolates: Structure, extraction, and functionality.” Food Reviews International, 34:2, 126-147, describes that the solubility of pea protein isolates is minimal around the isoelectric pH thereof, located around 4.5. The solubilities of commercial pea protein isolates do not exceed 20% between pH 4 and pH 5.

It is to the Applicant's credit to have already previously proposed a solution to improve this solubility by the patent application WO2011124862. Said application proposes carrying out a precise heat treatment making it possible to improve the functional properties of the plant proteins, in particular the solubility. However, this solubility is measured at neutral pH (7.5) and is always less than 20% at acidic pH (between 4 and 5).

Acid and/or enzymatic hydrolysis of the proteins is a well-known method which aims to hydrolyze the peptide bonds and thus reduce the degree of polymerization of the proteins. It is well known to the person skilled in the art that, the smaller the average size of the proteins, the more their solubility increases. The hydrolysis of a protein therefore makes it possible to increase the solubility thereof. However, with hydrolysis, the protein will also lose other functionalities such as the viscosity thereof or else the emulsifying ability thereof. The article by Poonam R. Bajaj, Kanishka Bhunia, Leslie Kleiner, Helen S. Joyner (Melito), Denise Smith, Girish Ganjyal & Shyam S. Sablani (2017), “Improving functional properties of pea protein isolate for microencapsulation of flaxseed oil.” Journal of Microencapsulation, 34:2, 218-230, describes enzymatic hydrolyses carried out with different proteases on a commercial pea protein isolate. This article confirms that hydrolysis makes it possible to increase solubility. However, like WO2011124862, said solubility is measured at neutral pH (7.4 which is the pH of the hydrolysis). On the other hand, the solubility at acidic pH remains less than 30%.

It is possible to envisage using other protein fractions such as albumins. However, while the latter are indeed more soluble at acidic pH, they also have functional properties, in particular a very high foamability, which may be undesirable in some industrial applications.

It is therefore still of interest to the person skilled in the art to obtain a legume protein isolate, in particular a pea protein, the degree of hydrolysis of which is low, for example less than 15%, but the solubility of which at acidic pH, for example at pH 5, is greater than 80%.

It is to the Applicant's credit to have developed a legume protein which meets these criteria.

### DISCLOSURE OF THE INVENTION

The present invention relates firstly to a legume protein containing more than 90% by weight of globulins relative to the total weight of proteins, said legume protein having:
a solubility at pH 5 of greater than 80%, preferably greater than 85%, even more preferably greater than 90%; and
a degree of hydrolysis of less than 15%, preferably less than 12%.

The present invention relates secondly to a method for preparing the legume protein according to the invention, comprising the following steps:
employing a legume protein isolate in aqueous solution;
hydrolyzing the isolate by adding a chymotrypsin-like serine protease enzyme so as to obtain a hydrolyzed legume protein having a degree of hydrolysis of less than 15%, preferably less than 12%;
optionally inhibiting the enzyme;
optionally drying the hydrolyzed legume protein.

Finally, the present invention also relates to the use of the legume protein according to the invention for the preparation of a human or animal food composition, a cosmetic composition or a pharmaceutical composition.

The invention will be better understood with the detailed description given below.

### DETAILED DESCRIPTION OF THE INVENTION

The legume protein of the present invention may in particular be a composition comprising a mixture of proteins extracted from a leguminous plant.

The legume protein according to the invention contains more than 90% by weight of globulins relative to the total weight of the proteins.

The term “protein” should be understood in the present application to mean the macromolecules formed from one or more polypeptide chains consisting of a sequence of amino acid residues bonded to one another by peptide bonds. In the particular context of pea proteins, the present invention relates more particularly to globulins (approximately 50-60% of the proteins of the pea) and albumins (20-25%). Pea globulins are mainly subdivided into three sub-families: legumins, vicilins and convicilins.

“Leguminous plant” or “legume” will be understood in the present application to mean the family of dicotyledonous plants of the Fabales order. This is one of the largest flowering plant families, third after Orchidaceae and Asteraceae in terms of number of species. It contains approximately 765 genera, bringing together more than 19,500 species. Several leguminous plants are important crop plants, including soy, beans, peas, chickpeas, faba beans, peanuts, cultivated lentils, cultivated alfalfa, various clovers, broad beans, carob and licorice.

The proteins extracted from these leguminous plants belong predominantly to the sub-groups of the globulins and albumins. In the present invention, the legume protein consists predominantly of globulins; in particular, it contains more than 90% by weight of globulins relative to the total weight of the proteins. Globulins can be distinguished from albumins by various methods well known to those skilled in the art, in particular by their solubility in water, with albumins being soluble in pure water, whereas globulins are only soluble in salt water. It is also possible to identify the albumins and globulins present in a mixture by electrophoresis or chromatography. A preferred method is described in the article “Peptide and protein molecular weight determination by electrophoresis using a high-molarity tris buffer system without urea.” Fling S P, Gregerson D S, Anal. Biochem. 1986; 155:83-88. The legume protein according to the invention contains more than 90% by weight of globulins relative to the total weight of the proteins.

The legume protein according to the invention has a solubility at pH 5 of greater than 80%, preferably greater than 85%, even more preferably greater than 90%.

According to a particular embodiment, the legume protein according to the invention may also have a solubility at pH 7 of greater than 80%, preferably greater than 85%, even more preferably greater than 90%.

The solubility may be measured by diluting the legume protein in distilled water, centrifuging the mixture and analyzing the supernatant, according to Test A for solubility, described below.

The legume protein according to the invention has a degree of hydrolysis of less than 15%, preferably less than 12%.

The degree of hydrolysis may be determined by measuring the content of free amino nitrogen relative to total nitrogen, according to Test B for degree of hydrolysis (test referred to as OPA test), described below.

The legume protein is preferably a faba bean protein or a pea protein. Pea protein is particularly preferred.

The term “pea” is considered here in its broadest accepted use and includes in particular all the varieties of “smooth pea” and “wrinkled pea” and all the mutant varieties of “smooth pea” and “wrinkled pea”, regardless of the uses for which said varieties are usually intended (human food, animal feed and/or other uses).

The term “pea” in the present application includes pea varieties belonging to the Pisum genus and more particularly to the species sativum and aestivum. Said mutant varieties are in particular those named “mutants r”, “mutants rb”, “mutants rug 3”, “mutants rug 4”, “mutants rug 5” and “mutants lam” as described in the article by C-L HEYDLEY et al., entitled “Developing novel pea starches.” Proceedings of the Symposium of the Industrial Biochemistry and Biotechnology Group of the Biochemical Society, 1996, pp. 77-87.

Even more preferably, the legume protein according to the invention is an isolate, the protein content of which is greater than 80% by weight relative to the weight of dry matter.

“Isolate” in the present application is intended to mean a composition comprising a protein content of greater than 80%, preferably greater than 90%, by weight relative to the weight of dry matter of the composition.

The protein content is measured by any technique well known to those skilled in the art. Preferably, the total nitrogen (in %/crude) is assayed, and the result is multiplied by the coefficient 6.25. This well-known methodology in the field of plant proteins is based on the observation that proteins contain on average 16% nitrogen. Any dry matter assay method well known to those skilled in the art may also be used.

The legume protein of the present invention may in particular be obtained by a method comprising the following steps:
employing a legume protein isolate in aqueous solution;
hydrolyzing the isolate by adding a chymotrypsin-like serine protease enzyme so as to obtain a degree of hydrolysis of less than 15%, preferably less than 12%;
optionally inhibiting the enzyme;
optionally drying the hydrolyzed legume protein.

According to a preferred embodiment, the legume protein isolate is selected from a faba bean protein isolate or a pea protein isolate. Pea protein isolate is particularly preferred.

The legume protein isolate used may originate from several sources, whether commercial or custom, but the isolate must not have undergone prior hydrolysis which reduced the size of the protein molecules from which it is formed. Preferably, the isolate will be obtained by carrying out the methods described in patents EP1400537 or EP1909593 from the Applicant.

Preferably, the aqueous solution of legume protein comprises from 5% to 20%, preferably from 8% to 12% by weight of dry matter relative to the weight of the aqueous solution.

Next, a chymotrypsin-like serine protease-type enzyme is added to the solution prepared in this way, so as to obtain a hydrolyzed legume protein having a degree of hydrolysis of less than 15%, preferably less than 12%.

In the present application, “protease” is intended to mean an enzyme which is able to cleave proteins or peptides by hydrolyzing their peptide bonds. In the present application, “serine protease” is intended to mean proteases having an active site containing a serine residue which plays an essential role in the catalysis. The different serine proteases are grouped together in international classification in the family EC 3.4.21.

The serine protease used in the present invention is chymotrypsin-like. “Chymotrypsin-like” is intended to mean a serine protease having a mode of action which is characterized in that the cleavage of the peptide bonds is located specifically after aromatic and hydrophobic amino acids, such as tyrosine, phenylalanine or leucine.

The amount by weight of enzyme needing to be added to obtain the desired degree of hydrolysis is quantified relative to the weight of proteins in the isolate employed in the method according to the invention. According to a particular embodiment, the amount of enzyme added is greater than 0.2%, preferably from 0.25% to 0.50%, by weight of enzyme relative to the weight of proteins in the isolate. It is also possible to add an amount of enzyme of greater than 0.5%. This will then give an identical result but in less time. The person skilled in the art will know how to adjust the amount of enzyme in order to achieve a desired reaction time.

After adding the enzyme, the hydrolysis reaction may be carried out with stirring. According to a particular embodiment, the hydrolysis is carried out for a duration of 30 min to 2 hours, preferably approximately one hour. As described above, this time may be reduced by increasing the amount of enzyme. This adjustment will be obviously accessible for the person skilled in the art.

According to a particular embodiment, the hydrolysis is carried out at a temperature of 45 to 65° C., preferably from 50 to 60° C., more preferably approximately 55° C. The heating may be carried out using any facility well known to those skilled in the art, such as a submerged heat exchanger. Preferably, the temperature is adjusted from 45 to 65° C. before adding the enzyme and is then regulated to +/−2° C. for the duration of the hydrolysis.

According to a particular embodiment, the hydrolysis is carried out at a pH of 8 to 10, preferably approximately 9. The pH may be adjusted by adding acid and/or base, for example sodium hydroxide or hydrochloric acid. The use of a buffer solution, while unnecessary, can be envisaged. Preferably, the pH is adjusted from 8 to 10 before adding the enzyme and is then regulated to +/−0.5 pH units for the duration of the hydrolysis.

Optionally, once the hydrolysis reaction has been completed, the enzyme can be inhibited. To this end, for example, the reaction medium may be adjusted to pH 7 and 90° C. for 5 min.

Optionally, the hydrolyzed legume protein can be dried by any well-known drying method, such as spray drying (single or multiple effects) or freeze drying. This drying may optionally be preceded by a filtration step making it possible to remove undesirable solid particles.

The legume protein of the invention may be used for the preparation of a human or animal food composition, a cosmetic composition or a pharmaceutical composition.

Indeed, because of its excellent solubility at acidic pH, such a legume protein is of particular interest in numerous industrial applications, in particular in the agri-food, cosmetics or pharmaceuticals industry, and in animal feed.

According to a particular embodiment, the legume protein according to the invention is used for the preparation of an acidic beverage, for example a soda.

Incorporation of the protein according to the invention in an acidic beverage is particularly advantageous. Indeed, unlike a standard protein, the latter will remain dissolved and will not tend to precipitate during the storage time. Thus, the use of the protein according to the invention makes it possible to obtain a storage-stable acidic beverage.

“Food composition” is intended to mean a composition intended for human or animal food. The term food composition covers food products, dietary supplements and beverages. “Cosmetic composition” is intended to mean a composition intended for a cosmetic use. “Pharmaceutical composition” is intended to mean a composition intended for therapeutic use.

The invention will be better understood by means of the following examples.

### EXAMPLES

Test Methods

Test A for Solubility

150 g of distilled water are introduced into a 400 ml beaker at 20° C.+/−2° C. by stirring with a magnetic stirrer bar, and precisely 5 g of legume protein sample to be tested are added. If required, the pH is adjusted to the desired value with 0.1 N NaOH. The content is supplemented with water to reach 200 g of water. Mixing is carried out for 30 minutes at 1000 rpm and centrifugation is carried out for 15 minutes at 3000 g. 25 g of the supernatant are collected and introduced into a crystallizing dish dried and tared beforehand. The crystallizing dish is placed in an oven at 103° C.+/−2° C. for 1 hour. It is then placed in a desiccator (with desiccant) to cool to ambient temperature, and is weighed.

The solubility corresponds to the content of soluble dry matter, expressed as % by weight relative to the weight of the sample. The solubility is calculated with the following formula:

$$\% solubility = \frac{( m 1 - m 2 ) \times ( 200 + P )}{P 1 \times P} \times 100 \qquad [ Math . 1 ]$$

where:
P=weight, in g, of the sample=5 g
m1=weight, in g, of the crystallizing dish after drying
m2=weight, in g, of the empty crystallizing dish
P1=weight, in g, of the sample collected=25 g

Test B for Degree of Hydrolysis (so-Called OPA Test)

The content of amino nitrogen (free NH₂) is determined first of all on the sample of proteins according to the invention with the MEGAZYME kit (reference K-PANOPA). The content of protein nitrogen (total nitrogen) of the sample is also determined. It is then possible to calculate the degree of hydrolysis.

Determining the Content of Amino Nitrogen:

The “amino nitrogen” groups of the free amino acids in the sample react with the N-acetyl-L-cysteine and ophthaldialdehyde (OPA) to form isoindole derivatives.

The amount of isoindole formed during this reaction is stoichiometric with the amount of free amino nitrogen. It is the isoindole derivative which is measured by the increase in absorbance at 340 nm.

A test specimen P*, exactly weighed, of the sample to be analyzed is introduced into a 100 ml beaker. This test specimen will be from 0.5 to 5.0 g based on the amino nitrogen content of the sample. Approximately 50 ml of distilled water is added, homogenization is carried out and the mixture is decanted into a 100-ml graduated flask. 5 ml of 20% sodium dodecyl sulfate (SDS) are added, and the mixture is supplemented with distilled water to reach a volume of 100 ml. Stirring is carried out for 15 minutes with a magnetic stirrer at 1000 rpm. A solution no. 1 is prepared by dissolving a tablet from bottle 1 of the Megazyme kit in 3 ml of distilled water and stirring is carried out until it is completely dissolved. It is necessary to provide one tablet per test. Solution no. 1 is prepared immediately before use.

A blank, a standard and a sample are directly prepared in the cuvettes of the spectrophotometer under the following conditions:
blank: introduce 3.00 ml of solution no. 1 and 50 μl of distilled water
standard: introduce 3.00 ml of solution no. 1 and 50 μl of bottle 3 of the Megazyme kit
sample: introduce 3.00 ml of solution no. 1 and 50 μl of the sample preparation.

The content of each cuvette is mixed and the measure of absorbance (A1) of the solutions is taken after approximately 2 mn in the spectrophotometer at 340 nm (spectrophotometer equipped with cuvettes with 1.0 cm of optical path, able to measure at a wavelength of 340 nm, and verified according to the procedure described in the related manufacturer's technical manual).

The reactions are then immediately initiated by adding 100 μl of solution no. 2, which corresponds to the OPA solution of bottle 2 of the Megazyme kit in each spectrophotometer cuvette.

The content of each cuvette is mixed and they are then placed in darkness for approximately 20 minutes.

The measure of absorbance A2 of the blank, the standard and the sample are then taken from the spectrophotometer at 340 nm.

The free amino nitrogen content, expressed as percentage by weight relative to the weight of the product, is given by the following formula:

$$\begin{matrix}\% amino nitrogen = \frac{\begin{matrix}( Δ A e c h - Δ A b l c ) \times \\ 3.15 \times 14.01 \times V \times 100\end{matrix}}{6803 \times 0.05 \times m \times 1000} & [ Math . 2 ] \\ \% amino nitrogen = \frac{( Δ A e c h - Δ A b l c ) \times 12.974 \times V}{m \times 1000} & [ Math . 3 ]\end{matrix}$$

### ΔAech=Aech2−Aech1

### ΔAblc=Ablc2−Ablc1

Aech2=absorbance of the sample after adding solution no. 2
Aech1=absorbance of the sample after adding solution no. 1
Ablc2=absorbance of the blank after adding solution no. 2
Ablc1=absorbance of the blank after adding solution no. 1
V=volume of the flask
m=weight of the test specimen in g
6803=extinction coefficient of the isoindole derivative at 340 nm (in l·mol−1·cm−1).
14.01=molar mass of the nitrogen (in g·mol−1)
3.15=final volume in the cuvette (in ml)
0.05=test specimen in the cuvette (in ml)

Determining the Content of Protein Nitrogen:

The content of protein nitrogen is determined according to the DUMAS method according to standard ISO 16634 (2016). It is expressed as percentage by weight relative to the weight of the product.

Calculation of the Degree of Hydrolysis

The degree of hydrolysis (DH) is calculated with the following formula:

$$D H = \frac{\% amino nitrogen}{\% protein nitrogen} \times 100 \qquad [ Math . 4 ]$$

### Example 1: Producing a Protein Isolate According to the Invention

Use is made of a commercial pea protein isolate NUTRALYS® S85F produced by ROQUETTE. The isolate contains 83% by weight of proteins relative to the weight of dry matter.

150 g of this isolate are introduced with 1290 g of drinking water at 20° C. in a stirred reactor with a volume of 1.5 liters. The temperature thereof is adjusted to 55° C. using a system of internal submerged pipes, connected to a temperature-regulating system. The pH is adjusted to 9 using solutions of 1M HCl and NaOH and a suitably calibrated pH meter.

0.3 g of the enzyme Formea® CTL600 (chymotrypsin-like serine protease) from NOVOZYMES is then added.

The reaction is controlled in this way for 1 hour, with permanent stirring.

The pH is then adjusted to 7 and the temperature to 90° C. for 5 minutes, to inhibit the enzyme.

The product is dried by freeze drying and corresponds to “Product according to the invention no. 1”.

### Example 2: Producing a Second Protein Isolate According to the Invention

The “Product according to the invention no. 2” is obtained according to example 1, using 0.6 g of enzyme Formea® CTL600 instead of 0.3 g.

### Example 3: Producing a Protein Isolate not According to the Invention for Comparative Purposes

The hydrolysis protocols for this example are derived from above example 1. The modifications in relation to the example are detailed in the table below. The amount of enzyme is expressed as percentage by weight relative to the weight of proteins in the isolate.

TABLE 1

| | | | temperature | time | amount of |
|---|---|---|---|---|---|
| Test | Enzyme | pH | (° C.) | (min) | enzyme |
| Comp 1 | Neutrase (B. | 7.4 | 50 | 120 | cf. Bajab |
| (Bajab | amyloliquefaciens, | | | | 2017 |
| 2017) | P1236-50ML) | | | | |
| Comp 2 | FERMGEN ® 2.5x | 3.5 | 50 | 60 | 0.50% |
| Comp 3 | Proteinase T | | 70 | 60 | 0.50% |
| Comp 4 | SEBDigest F24 P | 3 | 45 | 60 | 1.00% |
| Comp 5 | SEBDigest F35 P | 3 | 30 | 60 | 1.00% |
| Comp 6 | SEBDigest B7 P | | 60 | 300 | 1.00% |
| Comp 7 | Flavorpro ® | | 55 | 60 | 1.00% |
| | F750MDP | | | | |
| Comp 8 | Formea ® TL1200 | 9.5 | 55 | 60 | 0.50% |
| Comp 9 | Sumizyme ACP-G | 5 | 50 | 60 | 1.00% |
| Comp 10 | Fungal Protease | 7.3 | 55 | 60 | 0.50% |
| | 400 | | | | |

It should be noted that the enzymes used in this comparative example are not chymotrypsin-like serine proteases.

### Example 4: Comparison of the Different Products Obtained

For each sample, the degree of hydrolysis (DH), the solubility at pH 5 and the solubility at pH 7 are measured according to the tests described above.

The results are summarized in the table below:

TABLE 2

| | DH | Solubility | Solubility |
|---|---|---|---|
| Sample reference | (%) | pH 5 | pH 7 |
| Product according to the | 10.5 | 83.6 | 92.6 |
| invention no. 1 | | | |
| Product according to the | 11.5 | 92.4 | 94 |
| invention no. 2 | | | |
| Comp 2 | 7 | 57.4 | 76 |
| Comp 3 | 6.9 | 46 | 82.5 |
| Comp 4 | 9 | 68.7 | 81.2 |
| Comp 5 | 8.7 | 65.7 | 73.5 |
| Comp 6 | 11.6 | 74.8 | 80.4 |
| Comp 7 | 9.6 | 51.8 | 62.9 |
| Comp 8 | 10.7 | 58.6 | 89 |
| Comp 10 | 9.3 | 59.5 | 68.5 |

It is clearly apparent herein that only the use of a chymotrypsin-like serine protease makes it possible to obtain a protein isolate of a leguminous plant, in this case pea, which has a solubility at pH 5 of greater than 80% and a solubility at pH 7 of greater than 80%, while having a degree of hydrolysis of less than 12.

1. A legume protein containing more than 90% by weight of globulins relative to the total weight of proteins, wherein said legume protein has:
a solubility at pH 5 of greater than 80%, preferably greater than 85%, even more preferably greater than 90%; and
a degree of hydrolysis of less than 15%, preferably less than 12%.

2. The legume protein according to claim 1, wherein it has a solubility at pH 7 of greater than 80%, preferably greater than 85%, even more preferably greater than 90%.

3. The legume protein according to claim 1, wherein said legume protein is a faba bean protein or a pea protein, preferably a pea protein.

4. The legume protein according to claim 1, wherein said legume protein is an isolate the protein content of which is greater than 80% by weight relative to the weight of dry matter.

5. A method for preparing the legume protein as defined in claim 1, wherein preparing said legume protein comprises the following steps:
employing a legume protein isolate in aqueous solution;
hydrolyzing the isolate by adding a chymotrypsin-like serine protease enzyme so as to obtain a hydrolyzed legume protein having a degree of hydrolysis of less than 15%, preferably less than 12%;
optionally inhibiting the enzyme;
optionally drying the hydrolyzed legume protein.

6. The method according to claim 5, wherein the amount of enzyme added is greater than 0.2%, preferably from 0.25% to 0.50%, by weight of enzyme relative to the weight of proteins in the isolate.

7. The method according to claim 5, wherein the hydrolysis is carried out at a pH of 8 to 10, preferably approximately 9.

8. The method according to claim 5, wherein the hydrolysis is carried out at a temperature of 45 to 65° C., preferably from 50 to 60° C., more preferably approximately 55° C.

9. The method according to claim 5, wherein the hydrolysis is carried out for a duration of 30 min to 2 hours, preferably approximately 1 hour.

10. A use of the legume protein as defined in claim 1, for the preparation of a human or animal food composition, a cosmetic composition or a pharmaceutical composition, in particular for the preparation of a beverage with an acidic pH, for example a soda.
